(19) United States
(12) Patent Application Publication
(10) Pub. No.: US 2009/0104438 A1
(43) Pub. Date: Apr. 23, 2009

(54) ABRASION RESISTANT COATINGS

(76) Inventors: Jennifer Hoyt Lalli, Blacksburg, VA (US); Richard O. Claus, Eggleston, VA (US)

Correspondence Address: SHERR & VAUGHN, PLLC, 620 HERNDON PARKWAY, SUITE 200, HERNDON, VA, 20170, US

(21) Appl. No.: 12/253,306

(22) Filed: Oct. 17, 2008

Related U.S. Application Data
(60) Provisional application No. 60/980,751, filed on Oct. 17, 2007.

(51) Int. Cl. B32B 5/16; B05D 3/10

(52) U.S. Cl. 428/329; 428/323; 427/337; 427/340; 977/773

(57) ABSTRACT

A device includes a nanocomposite film, itself, having at least one nano-particle layer and at least one crosslinker layer. The device also includes an abrasion resistant coating over the nanocomposite film. A method for producing a device with an abrasion resistant nanocomposite coating on a substrate having a nano-particle-coated surface involves contacting nano-particle-coated surface with a crosslinker such that a chemical bond forms with nano-particles within the nano-particle-coated surface and this chemically bonded crosslinker is then contacted with at least one compound such that the at least one compound chemically binds to the crosslinker thereby forming an abrasion resistant coating on the substrate having the nano-particle-coated surface.

The present application claims priority to U.S. Provisional Patent Application No. 60/980,751 (filed Oct. 17, 2007) which is hereby incorporated by reference in its entirety.

### BACKGROUND

High performance coatings may be placed on substrates to enhance the mechanical, optical, electrical and environmental durability of the substrates in a variety of applications. Some examples of substrates that may be enhanced by high performance coatings include aircraft canopies and windows, automobile windshields and windows, visors and eyeglass lenses, pilot helmets, cell phone and computer displays, and sporting and medical equipment.

This wide range of applications for these substrates requires that the coatings have specialized properties such as high impact and abrasion/haze resistance. Furthermore, some substrates may require anti-reflection coatings to minimize glare and reduce degradation from ultra-violet rays, rain and cleaning solvents. In addition, some surfaces may build up electrostatic charge, thus requiring an electrostatic dissipative (ESD) protective coating.

Presently, there is a serious drawback associated with using polymer materials in thin films due to their susceptibility to marring and scratching by physical contact with harder materials. Continuous marring and scratching may result in impaired visibility and poor aesthetics, and may require replacement of the plastic components. For example, uncoated polycarbonate and acrylic substrates, which are commonly used in the applications mentioned above, are soft and susceptible to scratches and wear from dust or impact and require a hard impact and abrasion/haze resistant outermost coating.

Several techniques attempting to improve the abrasion wear resistance of plastic substrates use coating solutions which may be spread onto the desired substrates by dip, spray, spin, or flow techniques. The resulting coatings generally offer improvement of abrasion-resistance, but generally exhibit flow marks on the surface and an uneven coating thickness distribution that may cause undesirable optical aberrations.

Other techniques for forming abrasion-resistant coatings involve spin dip, spray or flow methods to form abrasion resistant coatings on smooth surfaces such as optical elements in spectacle lenses, for example. The build-up of the coating material at the outer edge of the lens, however, can cause optical aberration. These techniques are even less satisfactory when they are used to coat irregular surfaces. Moreover, the application of many of the prior abrasion resistance coatings require thermally activated initiators so the plastic substrates must be exposed to elevated temperature in order to fully develop the physical properties of the coating and to remove the solvents. Such high temperature processing may significantly degrade the quality of the plastic, through the incorporation of residual stresses.

Vapor deposition techniques for coating applications have also been employed. The technique typically involves the vapor deposition of a top layer of silicon dioxide onto an intermediate layer of an acrylate-type polymer that has, in turn, been coated onto a polycarbonate substrate. This evaporative technique of applying a layer of silicon dioxide, however, may be undesirable for several reasons, including (i) insufficient bond strength between the silicon dioxide layer and the underlying polymer layer; (ii) the resulting non-uniform surface is often characterized by pinholes, pits, and other imperfections; (iii) the difficulty to obtain uniformly thick coatings on curved or irregular or large-size substrates; (iv) the significant degradation of the plastic due to its exposure to high temperature; and (v) the spalling and cracking that occurs when the film thickness is increased greater than about 0.5 micrometers.

Further, recent advances in technology have increased the demand for improved nanocomposite materials for use in coatings that require strict tolerances on processing parameters. For example, current integrated circuit technology already requires tolerances on processing dimensions on a submicron scale. Self-assembly approaches have been developed for the fabrication of very thin films of composite materials. These self-assembly processes, however, while highly advantageous, generally are limited with respect to the types of materials that can be deposited by a particular process, by costs and manufacturing facilities.

Presently, nanocomposite materials are manufactured in large manufacturing facilities that are both expensive to build and to operate. For example, semiconductor device fabrication generally requires specialized microlithography and chemical etching equipment as well as extensive measures to avoid process contamination. Furthermore, the fabrication processes typically used to create electronic and electromechanical components involve harsh conditions, such as high temperatures and/or caustic chemicals. In addition, high temperatures also preclude fabrication on substrates such as flexible plastics, which offer widespread availability and lower costs.

### SUMMARY

Embodiments relate to a device that includes a nanocomposite film having at least one nano-particle layer and at least one crosslinker layer. The device also includes an abrasion resistant coating over the nanocomposite film.

Embodiments relate to a method for producing an abrasion resistant nanocomposite coating on a substrate having a nano-particle-coated surface. The nano-particle-coated surface is contacted with a crosslinker such that a chemical bond forms with nano-particles within the nano-particle-coated surface and this chemically bonded crosslinker is contacted with at least one compound such that the at least one compound chemically binds to the crosslinker thereby forming an abrasion resistant coating on the substrate having the nano-particle-coated surface.

### DRAWINGS

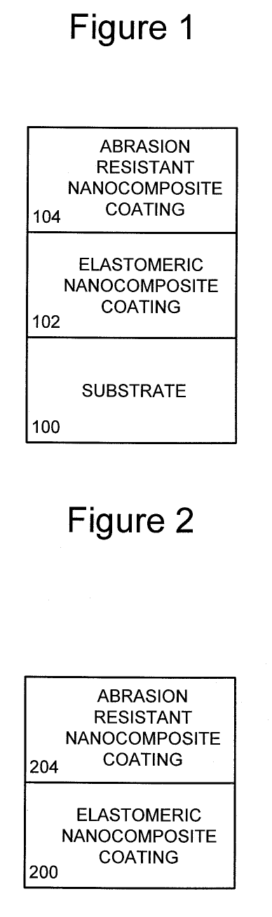

Example FIG. 1 illustrates a flexible conductive nanocomposite material on a substrate and having an abrasion resistant layer, in accordance with embodiments.

Example FIG. 2 illustrates a flexible conductive nanocomposite material having an abrasion resistant lay but without a substrate, in accordance with embodiments.

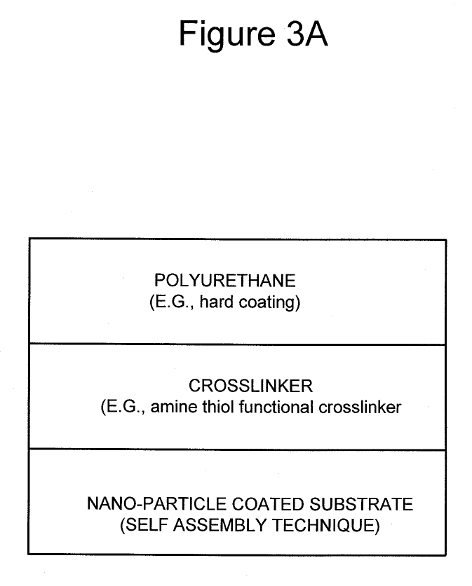

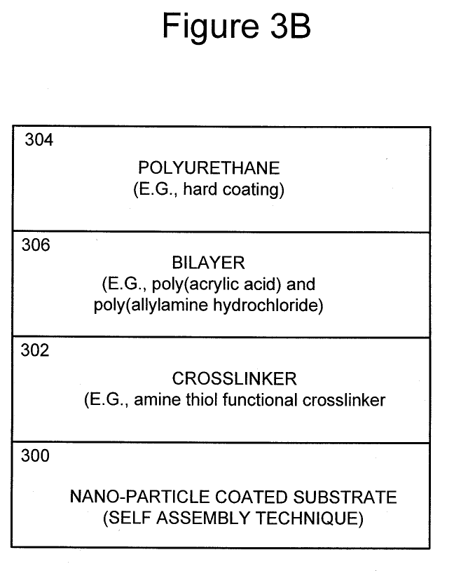

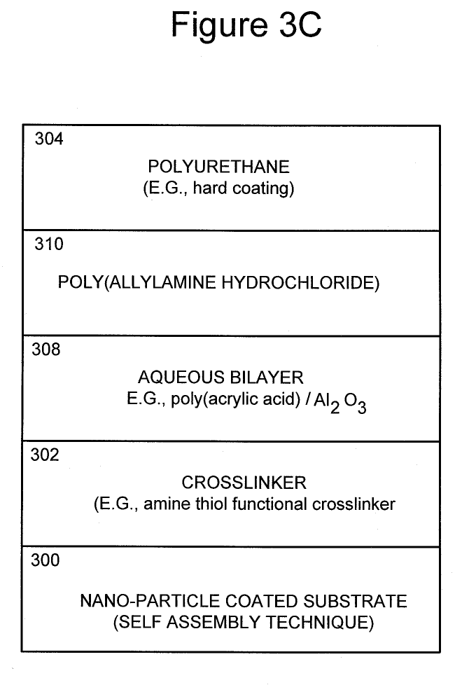

Example FIGS. 3A to 3C illustrate different techniques for providing an abrasion resistant layer on a nanocomposite material, in accordance with embodiments.

### DESCRIPTION

Example FIGS. 1A and 1B illustrate a flexible base material 18 with a flexible conductive material 21 formed on the flexible base material 18 that have shrinkable properties. Flexible conductive material 21 includes nano-size conductive particles 20, 22 that do not substantially deteriorate due to shrinking of flexible base material 18, in accordance with embodiments.

Nanocomposite materials such as the flexible, conductive nanocomposite layers depicted in FIGS. 1 and 2 may be generated in a variety of different ways in a variety of different configurations. For example, nanocomposite materials may be formed through self-assembly, in accordance with embodiments. U.S. patent application Ser. No. 10/774,683 (filed Feb. 10, 2004 and titled “RAPIDLY SELF-ASSEMBLED THIN FILMS AND FUNCTIONAL DECALS”) is hereby incorporated by reference in its entirety. U.S. patent application Ser. No. 10/774,683 discloses self-assembly of nano-particles, in accordance with embodiments. Nanocomposite materials may also be formed through related self-assembly processes as described in U.S. patent application Ser. No. 11/941,938 (filed Nov. 17, 2007 and titled “ROBUST ELECTRODES FOR SHAPE MEMORY FILMS”) and in U.S. patent application Ser. No. 12/033,889 (filed Feb. 19, 2008 and titled “SELF-ASSEMBLED CONDUCTIVE DEFORMABLE FILMS”) both of which are hereby incorporated by reference in their entirety.

In embodiments, the size (i.e. diameter or substantial diameter) of the nano-particles may be less than approximately 1000 nanometers. In embodiments, the size of the nano-particles may be less than approximately 50 nanometers. In embodiments, nano-particles may be gold and/or gold clusters. However, in other embodiments, nano-particles may be other metals (e.g. silver, palladium, copper, or other similar metal) and/or metal clusters. In embodiments, nano-particles may include metals, metal oxides, inorganic materials, organic materials, and/or mixtures of different types of materials. In embodiments, nano-particles may be semiconductor materials or non-conductive materials.

Through self assembly, nano-particles may be substantially uniformly and/or spatially dispersed during deposition to form a self assembled film, in accordance with embodiments. The self assembly of nano-particles may utilize electrostatic and/or covalent bonding of the individual nano-particles to a host layer (e.g. a linking agent material layer and/or a flexible base material). A host layer may be polarized in order to allow for the nano-particles to bond to the host layer, in accordance with embodiments. Since the deposition of the nano-particles may be dependent on individual bonding of the nano-particles to the host layer, a nano-particle material layer may have a thickness that is approximately the diameter of the individual nano-particles. Through a self-assembly deposition method, nano-particles that do not bond to a host layer may be removed, so that a nano-particles material layer is formed that is relatively uniform in thickness and material distribution.

In accordance with embodiments, methodologies for forming abrasion resistant nanocomposite coatings on substrates having a flexible nanocomposite coating are described along with the apparatus resulting from such methodologies. In particular, the methodologies may involve functionalizing the nano-particles within a flexible nanocomposite coating, followed by reacting the functionalized nano-particles with an abrasion resistant nanocomposite material to yield an abrasion resistant nanocomposite coating for a substrate that is coated with the flexible nanocomposite coating.

Abrasion resistance generally refers to the ability of a structure to withstand progressive removal of material from its surface as a result of mechanical collisions. Abrasion or surface wearing is typically improved by tailoring the desired surface to be harder than the surfaces of expected contact.

In accordance with embodiments, an abrasion resistant nanocomposite coating of may be applied directly onto a substrate that is coated with a flexible nanocomposite coating or onto a release film, resulting in a protective free-standing sheet, as shown in example FIG. 1 and FIG. 2. In FIG. 1, the substrate 100 is coated with a flexible nanocomposite film 102, which in turn, is coated with an abrasion resistant nanocomposite coating 104. Alternatively, as shown in FIG. 2, a flexible nanocomposite film 200 may be free-standing and coated with an abrasion resistant nanocomposite coating 204.

One example of an abrasion resistant nanocomposite coating, in accordance with embodiments, is an advanced polymer. The advanced polymer may include, but is not limited to, thermosetting resins, photosetting resins, phenolformaldehyde, phenol resins, epoxy resins, polyorganosiloxane resins, polyurethane, polyetherurethane resins, polyesters, polyimides, acrylates, and chemicals with moieties that may be capable of complexing nano-particles and reactive sidechain groups. Nanocomposites that are based on low stress copolymer networks may minimize debonding of highly mismatched substrates and undergo repeated thermal cycling. Such materials are cost effective since only a few groups per chain are necessary to yield stable nanocomposite dispersions and to allow for particle-particle overlap, hence excellent conductivity.

When introducing an abrasion resistant nanocomposite coating onto a nanocomposite film, the surface of the outermost layer may first be prepared to yield strong adhesion at the interface between the nano-particle film and the abrasion resistant nanocomposite coating. In accordance with embodiments, the surface preparation of the flexible nanocomposite film involves functionalizing the nano-particles in the film and then reacting the functionalized nano-particles with the abrasion resistant nanocomposite particles.

The adhesion promoting surface functionalization may be achieved using a polymer single layer or bilayer, for example, as well as a crosslinker reagent with at least two functional groups.

FIGS. 3A, 3B, and 3C illustrate three example methods of functionalization of a gold nano-particle layer 300. In FIG. 3A, the first functionalization method may involve the use of an amphiphilic crosslinker 302, such as an amine-thiol functional crosslinker, followed by deposition of a polyetherurethane hard coating 304. The functionalization with the amine-thiol crosslinker 302 may convert the outermost layer of the gold nano-particle surface 300 to an amine rich surface that will bind with the polyetherurethane hard coating 304.

The second method, as shown in FIG. 3B, involves the deposition of an amine-thiol crosslinker 302 followed by a bilayer 306 of poly(acrylic acid) and poly(allylamine hydrochloride), and finally the addition of the polyetherurethane hard coating 304.

The third functionalization method of FIG. 3C is capable of imparting alumina nano-particles into the hard coating in four steps. First, an amine/thiol crosslinker 302 is applied, then an aqueous bilayer 308 of poly(acrylic acid)/Al₂O₃ is applied, and then a layer 310 of poly(allylamine). Finally the polyetherurethane hard coating 304 may be applied.

The reagent that is used to functionalize the nanocomposite film may include polymers having functional groups that are capable of reacting with the nano-particle ligands in the substrate's nano-particle coating. Advanced polymers may be used to incorporate functionalized nano-particles for deposition onto chemically surface treated transparent polymer substrates. The polymers may be selected based on abrasion, chemical and environmental resistance.

The crosslinkers of the invention are molecules that comprise at least one functional group that may be capable of covalently or noncovalently binding to the desired molecule, such as the nano-particle or polymer. The crosslinker provides bonding capabilities that may lead to complex formation. The crosslinker may include more than two functional groups, including, but not limited to, a hydroxyl group, an amino group, a carboxyl group, a carboxylic acid anhydride group, a mercapto group, and a hydrosilicon group. The frame of the linker supporting the functional group may be inorganic or organic. The frame may comprise silyl and/or siloxy moieties, linear or branched carbon chains, cyclical carbon moieties, saturated carbon moieties, unsaturated carbon moieties, aromatic carbon units, halogenated carbon groups and combinations thereof.

Additionally, the structure of the crosslinker may be selected to yield desirable properties of the composite. For example, the size of the linker may be a control parameter that may affect the periodicity of the composite and the self-organization properties.

As described with respect to FIG. 3C, an abrasion resistant coating may include an inorganic-organic hybrid nanocomposite including an advanced polymer, such as a polyetherurethane, and molecularly monodisperse ceramic nano-particles that may be covalently tied together to form a polymer/ceramic network structure, in accordance with embodiments. Exemplary ceramic particles may include, but are not limited to, Al₂O₃ and TiO₂. The use of polymer toughened ceramic nanocomposites may provide the hardness required for good abrasion resistance and impact resistance as the organic portion of the polymer/ceramic abrasion resistant nanocomposite coating can absorb energy upon impact with materials in the atmosphere. Such nanocomposites do not have the brittleness associated with sputtered ceramic coatings.

The covalent integration of particular nano-particles within the abrasion resistant coating may generate a less transparent and more abrasion resistant nanocomposite coating. However, transparency of the coating may be achieved by incorporating ceramic nano-particles into stable high quality abrasion resistant dispersions.

In accordance with embodiments, abrasion resistant nanocomposite coatings may also be formed on polyurethane matrices. Polyurethanes have strong hydrogen bonding segments that are capable of effectively dispersing ceramic nano-particles such as Al₂O₃. This system results in μm-mm thick coatings with high impact resistance properties. The polyurethane nanocomposites may include prepolymers, Al₂O₃, ZrO₂, and other additives to protect the coatings from electrostatic discharge while offering abrasion and impact resistance, which function as one step multifunctional coatings.

Polyurethane nanocomposite matrices may be formed by the reaction of diisocyanate reagents with polyol reactive oligomers or diamine reagents, for example. Polyurethane ionomers may be formed when one of the reactive components contain ionic moieties. When reagents having at least about three functional groups are reacted, crosslinked polyurethane networks may be obtained. Both polyesterurethanes and polyetherurethanes may be desirable for use as transparent impact resistant coatings. Independent polyesterurethanes may yield harder coatings, greater high temperature hydrolytic stability, and lower processing viscosities than polyetherurethanes. Both polyesterurethanes and polyetherurethanes may be desirable as transparent impact resistant coatings.

For example, hexamethylene-1,6-diisocyanate (HMDI) may be reacted with poly(tetramethylene oxide)diol to form oligomeric prepolymers that may be further reacted with trimethylol propane to yield a polyetherurethane network. A thiol moiety, for example, of an amine-thiol crosslinker may bond strongly with Au nano-particles at the surface of a gold nano-particle film leaving amine moieties available for reactions with isocyanate in HMDI. This results in a urea linkage that is a much stronger hydrogen bonding moiety compared to urethane. This strong adhesive bond may prevent delamination and chemical integration of the nano-particle self-assembled layers. Similarly, ceramic nano-particles added to the polyetherurethane formulation may become covered with hydroxyl moieties from the HMDI present in the polyetherurethane formulation to form an inorganic-organic hybrid abrasion resistant nanocomposite coating.

Additionally, in accordance with embodiments, abrasion resistant nanocomposite coatings including polysiloxanes may be formed on the nanocomposite films. Here, polysiloxanes that contain both a controlled number of reactive sites available for both bonding to ceramic (e.g. Al₂O₃) nano-particles and for crosslinking reactions may be used. Polysiloxanes may offer excellent weatherability including degradation resistance against ozone and UV. Lower stress adhesive nanocomposites based on polysiloxanes may also minimize debonding affects that occur when bonding substrates with highly mismatched coefficients of thermal expansion. Polyorganosiloxanes are also known for their high flexibility over a wide service temperature range. Such networks may remain flexible under cryogenic conditions and are mechanically consistent at temperatures greater than about 250° C. Polyorganosiloxanes with pendent quaternized phosphine, phosphine oxide, and nitrile moieties are known to complex with oxide and metal nano-particles with hydroxyl rich surfaces.

Polysiloxanes with pendent carboxylic acid moieties and condensation sites that may covalently bond with hydroxyl rich metal and oxide nano-particles, specifically Al₂O₃, may also be used as abrasion resistant coatings. For example, cationic quaternized phosphonium ion containing polyorganosiloxanes and anionic carboxylate-containing polyorganosioxanes may participate in self assembly processes with Al₂O₃. Polysiloxane based ionomers may be used to form ultrathin crosslinked hard coats (nm scale) via electrostatic self assembly. Such materials, having controlled amounts of vinyl groups along the backbone, may be crosslinked with a silane crosslinker (tetrakis(dimethylsiloxy)silane) in the presence a Platinum (Pt) catalyst to form hard abrasion resistant coatings.

In general, the various abrasion resistant nanocomposite coatings described above may be applied by a method such as spin coating, spraying, web-based processes, ink jet printing, and a combination thereof. Furthermore, the specific structure and components of the abrasion resistant nanocomposite coatings may be selected to offer desired electrical conductivity, electrostatic dissipation (ESD protection), control over electromagnetic absorption and reflection (electromagnetic interference or EMI shielding), and use as a ground plane for electronic circuits on substrates. The coatings may also provide abrasion resistance including dust and sand erosion protection and offer mechanical compliance and protection against cracking and degradation upon mechanical impact.

In accordance with embodiments, the abrasion resistant nanocomposite coatings may also provide environmental protection to its substrate against ozone, ultraviolet (UV), radiation, rain, and extreme thermal variations from temperatures in the range of about −80° C. to about 200° C.

These abrasion resistant nanocomposite coatings may be applicable for use in aircraft and automotive transparencies including canopies, windows, optical sensors, infra-red sensors and other transparent subsystems. In addition, the abrasion resistant nanocomposite coating may be used in transparent conducting coatings for optical displays such as light emitting diodes (LED), LED arrays, lasers, semi-conductor lasers, semi-conductor laser displays, and flexible displays. The nanocomposite coatings may be used in optical and opto-electronic detectors including charge coupled device (CCD) arrays, photovoltaics, photodiodes, phototransistors, flexible detectors, flexible detector arrays, micro-opto-electro-mechanical systems and detectors, and wearable electronics, detectors and displays.

The coatings may be deposited uniformly across the surface of the substrates, patterned laterally parallel to the plane of the surface, or graded in thickness perpendicular to the surface through multiple layers. Such films may be used to impart new properties to existing substrates or materials that do not have the properties of such surface coatings.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A device comprising:
a nanocomposite film including at least one nano-particle layer and at least one crosslinker layer, and
an abrasion resistant coating over the nanocomposite film.

2. The device of claim 1, further comprising:
a substrate on which the nanocomposite film is located.

3. The device of claim 1, wherein the nanocomposite film comprises a flexible conductive film.

4. The device of claim 1, wherein the at least one nano-particle layer has one or more nano-particles selected from the group consisting of metallic nano-particles, semiconducting nano-particles, magnetic nano-particles, ceramic nano-particles, and dielectric nano-particles, and a combination thereof.

5. The device of claim 4, wherein the ceramic nano-particles include at least one material selected from the group consisting of Al₂O₃ and TiO₂.

6. The device of claim 1, further comprising:
a polymer layer between the nanocomposite film and the abrasion resistant coating.

7. The device of claim 6, wherein the polymer layer comprises a bilayer of polyacrylic acid and polyallylamine hydrochloride.

8. The device of claim 6, wherein the polymer layer comprises an aqueous bilayer of polyacrylic acid/Al₂O₃ and polyallylamine.

9. The device of claim 1, wherein the device is transparent.

10. The device of claim 1, wherein the crosslinker layer has at least one functional group selected from the group consisting of hydroxyl groups, amino groups, carboxyl groups, carboxylic acid anhydride groups, mercapto groups, hydrosilicon groups, and a combination thereof

11. The device of claim 1, wherein the abrasion resistant coating includes at least one material selected from the group consisting of thermosetting resins, photosetting resins, phenolformaldehyde, phenol resins, epoxy resins, polysiloxanes, polyorganosiloxanes, polyurethanes, polyetherurethanes, polyesterurethanes, polyesters, polyimides, acrylates, poly(urethane)-co-(siloxane), and poly(dimethyl-co-methylhydrido-co-3-cyanopropyl, methyl) siloxane, and chemicals with moieties that are capable of complexing nano-particles and reactive sidechain groups.

12. A method for producing an abrasion resistant nanocomposite coating on a substrate having a nano-particle-coated surface, said method comprising:
contacting the nano-particle-coated surface with a crosslinker such that a chemical bond forms with nano-particles within the nano-particle-coated surface; and
contacting the chemically bonded crosslinker with at least one compound such that the at least one compound chemically binds to the crosslinker thereby forming an abrasion resistant coating on the substrate having the nano-particle-coated surface.

13. A method of claim 12, wherein said crosslinker comprises having at least two functional groups such that:
a first functional group forms the chemical bond with the nano-particles within the nano-particle-coated surface; and
a second functional group that chemically binds with the at least one compound.

14. The method of claim 12, wherein the nano-particles within the nano-particle-coated surface are gold nano-particles, the crosslinker is an amine thiol functional crosslinker, and the abrasion resistant nanocomposite coating is a polyetherurethane hard coating.

15. The method of claim 12, further comprising:
forming at least one polymer layer between the nano-particle-coated surface and the abrasion resistant nanocomposite coating by contacting the nano-particle-coated surface with a crosslinker reagent and contacting the crosslinker reagent with at least one polymer.

16. The method of claim 15, wherein the at least one polymer layer is a bilayer.

17. The method of claim 12, wherein the abrasion resistant coating comprises a polyurethane nanocomposite coating.

18. The method of claim 12, wherein the abrasion resistant coating comprises an inorganic-organic hybrid nanocomposite comprising molecularly monodisperse ceramic nano-particles selected from the group consisting of Al₂O₃ and TiO₂ and a polymer.

19. The method of claim 12, wherein the abrasion resistant coating is transparent.

20. The method of claim 12, wherein the nano-particles have a diameter in the range of about 1 nm to about 1000 nm.
